(19) United States
(12) Patent Application Publication
(10) Pub. No.: US 2007/0228847 A1
(43) Pub. Date: Oct. 4, 2007

(54) HIGH SPEED ELECTRIC MOTOR

(75) Inventor: Cheon Kyung KIM, Pusan (KR)

Correspondence Address: GREENBLUM & BERNSTEIN, P.L.C., 1950 ROLAND CLARKE PLACE, RESTON, VA, 20191, US

(73) Assignee: KOREA FLUID MACHINERY CO., LTD., Gyeongsangnam-do (KR)

(21) Appl. No.: 11/690,885

(22) Filed: Mar. 26, 2007

(30) Foreign Application Priority Data
Mar. 30, 2006 (KR) 10-2006-0028835
Sep. 21, 2006 (KR) 10-2006-0091713

(51) Int. Cl. H02K 9/00; H02K 1/32

(52) U.S. Cl. 310/61; 310/156.28; 310/59; 310/156.11

(57) ABSTRACT

Provided is a high speed electric motor including a stator installed at an inner circumferential surface of a motor housing; and a rotor installed inside the rotor to form a rotational magnetic field by application of a current to the stator, and having a cooling passage through which fluid flows and a magnet installed at one side of the cooling passage.

This application claims the benefit of Korean Application Nos. 10-2006-28835 and 10-2006-91713 which were filed on Mar. 30, 2006 and Sep. 21, 2006 respectively, which were hereby incorporated by reference as if fully set forth herein.

### BACKGROUND OF THE INVENTION

1. Field of the Invention

The present invention relates to a high speed electric motor, and more particularly, to a high speed electric motor having a good cooling effect.

2. Background of the Related Art

Generally, in a brushless direct current (BLDC) motor having no brush and commutator, there is no need to perform periodical maintenance, and thus it is possible to provide high reliability and efficiency, and prevent electric spark and mechanical noise. For these reasons, the BLDC motor has been widely used in various fields, for example, small-sized high speed applications such as a dental instrument, a medical instrument or a high speed centrifuges, and industrial high speed applications such as a turbo compressor, a spindle, a grinder, a high speed drill, a turbo motor for air compression or a high speed electric motor generator, and so on.

Hereinafter, a conventional high speed electric motor will be described with reference to FIG. 1.

The conventional high speed electric motor generally includes a housing 100, a stator 110, a rotor 10, and a magnet part 65.

The housing 100 functions as a body of the high speed electric motor and has a hollow structure for accommodating various components.

The stator 110 is formed by laminating a plurality of thin plates, has windings, and fixed in the housing 100.

An upper cover 210 is fastened to one end of the housing 100 to form an upper part of the high speed electric motor, and a lower cover 220 is fastened to the other end of the housing 100 to form a lower part of the high speed electric motor.

The rotor 10 is supported by bearings at its both ends, and rotated by forming a rotational magnetic field with the stator 110.

Meanwhile, in order to obtain high speed rotation, when the motor is driven at a high frequency, a core loss is generated. In addition, heat is generated in the rotator 10 due to the core loss, and temperature may increase.

Since the high temperature may badly affect the high speed electric motor, a method of supplying separate power has been proposed to use a fluid such as air or water in order to cool the high speed electric motor.

As a result, when the high speed electric motor is driven, a fluid is introduced into the high speed electric motor through a hole formed at the lower cover 220 of the high speed electric motor to flow between the stator 110 and the rotor 10, and then discharged to the exterior through a hole formed at the upper cover 210.

However, the conventional high speed electric motor has the following problems.

First, while the interior of the stator and the exterior of the rotor can be cooled, the interior of the rotor cannot be cooled.

Second, an output of the high speed electric motor may be lowered due to increase of the interior temperature and generation of the core loss of the high speed electric motor to decrease efficiency thereof.

Third, the heat generated by the rotor may cause demagnetization of the magnet in high temperature.

Fourth, the heat generated due to the core loss may cause thermal deformation of the rotor 10 to result in unstable high speed rotation and damage of bearings for supporting both ends of the rotor.

### SUMMARY OF THE INVENTION

In order to solve the problem, the present invention provides a high speed electric motor having a heat radiation structure for stably driving the motor even when the motor is rotated at a high speed.

In order to accomplish the above and other aspects, a high speed electric motor in accordance with an exemplary embodiment of the present invention includes a stator installed at an inner circumferential surface of a motor housing; and a rotor installed inside the rotor to form a rotational magnetic field by application of a current to the stator, and having a cooling passage through which fluid flows and a magnet installed at one side of the cooling passage.

Here, the cooling passage may include: a main passage formed in the rotor in an axial direction and having one end passing through a tip of the rotor; and discharge branch passages extending from the other end of the main passage through an outer circumferential surface of the rotor and divided into at least two branch paths. In addition, the discharge branch passages may be formed perpendicular to the axial direction of the rotor. The discharge branch passages may form an obtuse angle with the main passage.

The high speed electric motor may further include a centrifugal impeller engaged with an end of the rotor to be rotated therewith and blowing a cooling fluid. A main frame may be installed at a center part of the rotor to have a convex shape, and a magnet may be coupled with the main frame along its inner circumferential surface. A reinforcement frame may be installed inside the main frame to reinforce the main frame.

Meanwhile, in another embodiment in accordance with the present invention, the rotor may include: a lower frame disposed inside the rotor in an axial direction of the rotor which is installed at an inner circumferential surface of the motor housing and receives power to generate a magnetic force, and having an introduction passage formed through its one end to introduce fluid thereinto; a ring frame coupled with the other end of the lower frame in its axial direction, and having a hollow cylindrical space; a magnet installed inside the ring frame to form a rotational magnetic field by application of a current to the stator, and having central branch passages formed at its outer circumferential surface in its axial direction to be in communication with the introduction passage to move the fluid introduced through the introduction passage; and an upper frame coupled with an end of the ring frame in its axial direction, and having a discharge passage installed at its inner circumferential surface in its axial direction to be in communication with the central branch passages to discharge the fluid flowing toward the central branch passages.

Here, the central branch passages may have a symmetrical cross-section about a polarization line of the magnet. The lower frame and the ring frame may be integrally formed with each other. The ring frame may be integrally formed with the upper frame.

The discharge passage may be branched into at least two discharge branch passages passing through an outer circumferential surface of the upper frame at an end of the discharge passage such that the fluid moving through the discharge passage is discharged to the exterior of the upper frame.

### BRIEF DESCRIPTION OF THE DRAWINGS

The above and other objects, features and advantages of the present invention will be more apparent from the following detailed description taken in conjunction with the accompanying drawings, in which:

FIG. 1 is a cross-sectional view showing a structure of a conventional high speed electric motor and cooling air flow therein;

FIG. 2 is a cross-sectional view showing fluid flow in a high speed electric motor in accordance with an exemplary embodiment of the present invention;

FIGS. 3 and 4 are cross-sectional views of a rotor employed in the high speed electric motor in accordance with an exemplary embodiment of the present invention;

FIG. 5 is a longitudinal cross-sectional view of a rotor in accordance with another exemplary embodiment of the present invention;

FIG. 6 is a cross-sectional view taken along line A-A of FIG. 5;

FIG. 7 is a longitudinal cross-sectional view of a rotor in accordance with still another exemplary embodiment of the present invention; and

FIG. 8 is a cross-sectional view taken along line B-B of FIG. 7.

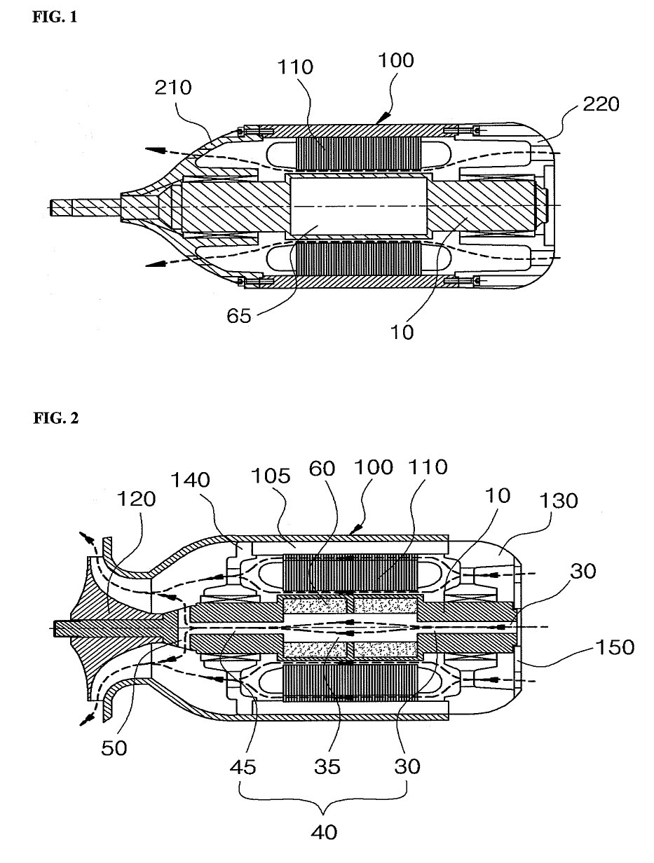

### DETAILED DESCRIPTION OF THE PREFERRED EMBODIMENT

Hereinafter, exemplary embodiments in accordance with the present invention will be described in detail with reference to the accompanying drawings. Throughout the invention, like reference numerals designate like components, and their description will not be repeated.

A high speed electric motor in accordance with an exemplary embodiment of the present invention will now be described in detail with reference to the accompanying drawings.

FIG. 2 is a cross-sectional view of a high speed electric motor in accordance with an exemplary embodiment of the present invention.

As shown in FIG. 2, the high speed electric motor in accordance with an exemplary embodiment of the present invention includes a housing 100, and a stator 110 coupled with a fixing part 105 installed at an inner circumferential surface of the housing 100. The stator 110 may be formed by laminating a plurality of thin plates having windings, and fixed inside the fixing part 105.

In addition, a plurality of bobbins, on which coils are wound, project from an inner surface of the stator 110, and have predetermined spaces formed therebetween.

Bearings are installed at an upper fixing part 140 and a lower fixing part 130 disposed at upper and lower sides of the fixing part 105, and coupled with an outer circumferential surface of a rotor 10.

Specifically, the rotor 10 is coupled to pass through the upper fixing part 140, the stator 110, and the lower fixing part 130, and a centrifugal impeller 120 is fixed to an end of the rotor 10 through the upper fixing part 140.

Therefore, when power is applied to the stator 110, a rotational magnetic field is formed between the rotor 10 and the stator 110 to rotate the rotor 10. At this time, the centrifugal impeller 120 coupled with one side of the rotor 10 is rotated to blow air so that the fluid flows in the high speed electric motor.

Meanwhile, a main frame 20 is formed at an outer circumferential surface of the rotor 10.

The main frame 20 may project from an outer circumferential surface of a center part of the rotor 10, and a magnet 60 and a reinforcement frame 25 may be installed in the main frame 20. The magnet 60 is coupled with an inner circumferential surface of the main frame 20, and has a hollow part to form a portion of a main passage 40.

In addition, the outer circumferential surface of the magnet 60 may be formed to be in contact with an inner circumferential surface of the main frame 20, at which the magnet 60 is installed. Further, a plurality of magnets 60 may be coupled with the rotor 10.

Meanwhile, the reinforcement frame 25 may be press-fitted into the inner circumferential surface of the main frame 20, and may be installed between the magnets 60.

Further, the outer circumferential surface of the reinforcement frame 25 may be in contact with the inner circumferential surface of the main frame 20. Furthermore, the reinforcement frame 25 may have a predetermined angle with respect to a rotary shaft of the rotor 10, and may be a ring plate having a polygonal cross-section.

As a result, it is possible to prevent vibration generated during rotation of the rotor 10, and damage of the main frame 20 due to a centrifugal load applied to the main frame 20 by the centrifugal force.

Hereinafter, the fluid flow formed in the high speed electric motor will be described in detail.

When the rotor 10 is rotated, the centrifugal impeller 120 fixed to an end of the rotor 10 is rotated to blow the fluid. At this time, the fluid outside the high speed electric motor is introduced into the housing 100 through a through-hole formed at the lower cover 150 installed at the end of the housing 100. The introduced fluid may be introduced around the stator 110 through the through-hole formed at the lower fixing part 130, or introduced into an introduction passage 30 of the main passage 40 passing through a center part of the rotor 10.

First, the fluid introduced around the stator 110 passes between the bobbins to perform a cooling operation, and then passes through a through-hole of the upper fixing part 140 to be discharged to the exterior. As a result, a large amount of heat generated by the stator 110 may be radiated to the exterior of the high speed electric motor through the fluid flow.

In addition, the fluid introduced into the main passage 40 formed in the rotor 10 cools the rotor 10.

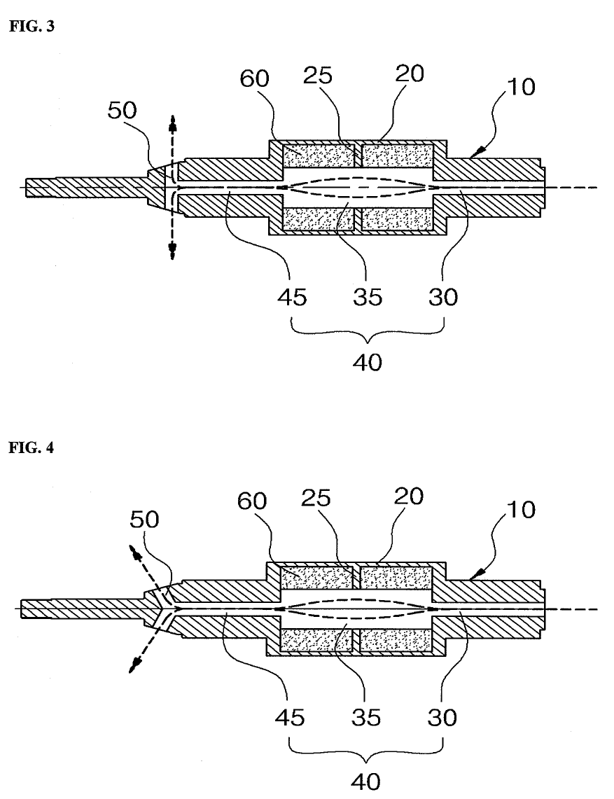

FIGS. 3 and 4 are cross-sectional views showing an inner structure of a rotor in accordance with an exemplary embodiment of the present invention.

As shown in FIG. 3, a main passage 40 is formed to pass through the rotor 10.

Specifically, the main passage 40 is formed in an axial direction of the rotor 10, and includes an introduction passage 30, a connection passage 35, and a discharge passage 45. Here, the connection passage 35 is formed to pass through the magnet 60 and the reinforcement frame 25 disposed at the center part of the rotor 10. At this time, since the magnet 60 affecting the rotational magnetic field has the largest caloric value, the connection passage 35 may have a cross-section larger than that of the introduction passage 30 to increase a contact surface with the air. As a result, it is possible to enlarge a heat radiation area, thus improving cooling efficiency.

In addition, a discharge branch passage 50 is formed at an end of the discharge passage 45 of the main passage 40 to pass through the rotor 10 from a center part thereof in a radial direction. Therefore, the introduced air sequentially passes through the introduction passage 30, the connection passage 35, the discharge passage 45, and the discharge branch passage 50. Here, a plurality of discharge branch passages 50 may be formed in radial directions of the rotor 10.

Moreover, the discharge branch passages 50 may be formed perpendicular to an axial direction of the rotor 10. That is, as shown, the discharge branch passages 50 have a T-shaped cross-section to pass through the rotor 10 in radial directions. In this case, the centrifugal force generated due to rotation of the rotor 10 may be maximally applied to the discharge branch passages 50 to improve the fluid flow in the cooling passage.

As described above, the fluid can be smoothly discharged through the discharge branch passages 50 by the suction force generated due to rotation of the centrifugal impeller 120 and the centrifugal force generated by the discharge branch passages 50 during rotation of the rotor 10. The fluid discharged as described above is discharged to the exterior of the high speed electric motor through the centrifugal impeller 120.

Meanwhile, referring to FIG. 4, the discharge branch passages 50 may form an obtuse angle with the main passage 40. Here, the obtuse angle means that the discharge branch passages 50 are formed to pass through the rotor 10 in a radial direction to form a “Y” shape in an axial direction of the rotor 10. Therefore, the fluid passing through the discharge branch passages 50 can be more smoothly discharged toward the centrifugal impeller (see FIG. 2) by the centrifugal force generated during rotation of the rotor 10.

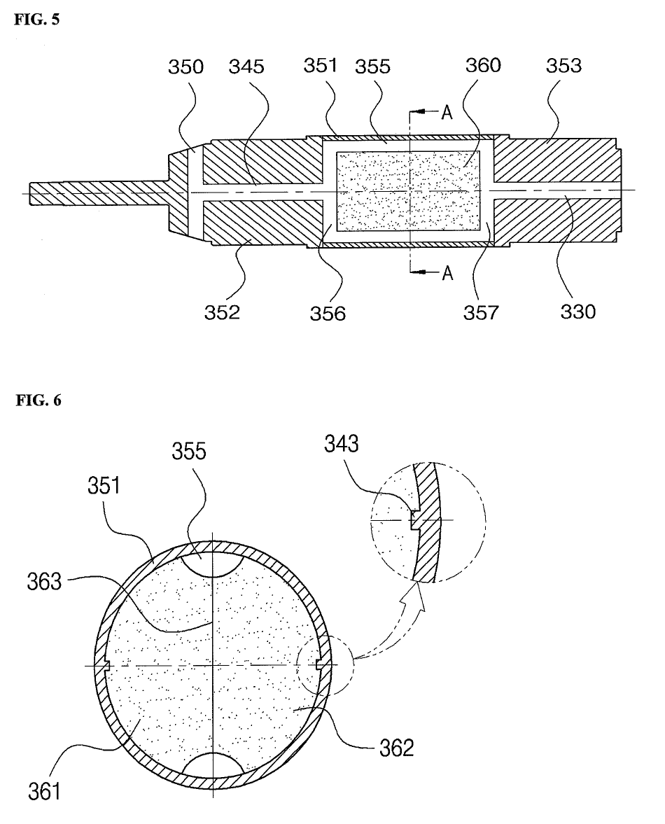

FIG. 5 is a longitudinal cross-sectional view of a rotor employed in a high speed electric motor in accordance with another exemplary embodiment of the present invention, and FIG. 6 is a cross-sectional view taken along line A-A of FIG. 5. Since the basic constitution of the rotor in accordance with another embodiment of the present invention is the same as the embodiment, its description will not be repeated.

As shown in FIGS. 5 and 6, the rotor in accordance with another embodiment of the present invention includes a magnet 360, a lower frame 353, a ring frame 351, and an upper frame 352. Here, the magnet 360 is inserted into the ring frame 351, and the lower frame 353 and the upper frame 352 are coupled with both ends of the ring frame 351. In addition, fluid introduced into the lower frame 353 through one end of the lower frame 353 passes through the ring frame 351, and then moves into the upper frame 352 to be discharge to the exterior of the upper frame 352.

Specifically, an introduction passage 330 is formed to pass through the lower frame 353. The ring frame 351 having a cylindrical shape is coupled with an end of the lower frame 353 in an axial direction of the rotor in various manners such as a threaded engagement, a welding, and a press fitting. Here, the ring frame 351 and the lower frame 353 may be formed of the same material so that they can be readily fixed to each other through the welding.

In addition, the magnet 360 is inserted into the ring frame 351 so that an outer circumferential surface of the magnet 360 is fixed to an inner circumferential surface of the ring frame 351. Here, in order to prevent scattering and deformation of the magnet 360 when the ring frame 351 is rapidly rotated, the ring frame 351 may be formed of a non-magnetic metal having sufficient strength and allowing magnetic force to pass through the ring frame 351.

Of course, the magnet 360 may have at least one pair of polarities, i.e., an N-polarity 361 and an S-polarity 362, which are symmetrically and alternately magnetized in an axial direction of the ring frame 351.

In addition, in order to prevent decrease in adhesion between the ring frame 351 and the magnet 360 and slippage of the magnet 360 due to the moment of inertia when the magnet 360 is rotated or stopped, fixing ribs 343 may project inward from the inner surface of the ring frame 351.

Further, at least one pair of fixing ribs 343 may be formed symmetrical to each other about a polarization line 363. The fixing ribs 343 may have cross-sections of various shapes without any limitation. Here, the polarization line 363 means an interface between the N-polarity 361 and the S-polarity 362.

Furthermore, the fixing ribs 343 may have a predetermined length in an axial direction of the ring frame 351 to increase a contact surface of the magnet 360 with the fixing rib 343 so that coupling between the magnet 360 and the ring frame 351 using the fixing ribs 343 can be more strengthened.

Meanwhile, central branch passages 355 may be formed in the ring frame 351 such that the fluid introduced through the introduction passage 330 can move into the ring frame 351.

Here, in order to simultaneously cool the magnet 360 formed of a sintered alloy and having low thermal conductivity and the ring frame 351 having a predetermined thickness and relatively readily deformable by heat, the central branch passages 355 may be formed between the magnet 360 and the ring frame 351.

As a result, the fluid moving to the central branch passages 355 is in direct contact with the magnet 360 and the ring frame 351 to more effectively cool the magnet 360 and the ring frame 351.

In addition, in order to maintain uniformity in the size and shape of the N-polarity 361 and the S-polarity 362 and the coercive force of the magnet 360, the central branch passages 355 have a cross-section symmetrical about the polarization line 363.

Here, the central branch passages 355 have a recessed semi-circular shape or a flat shape at an outer circumferential surface of the magnet 360 in its axial direction and pass through both ends of the magnet 360 such that the fluid can move.

Meanwhile, the central branch passages 355 may have various cross-sections symmetrical about the polarization line 363, without any limitation. Therefore, the central branch passages 355 may be defined by partial outer surfaces of the N-polarity 361 and the S-polarity 362 and a partial inner circumferential surface of the ring frame 351.

Specifically, when the magnet 360 is formed of each one N-polarity 361 and S-polarity 362, a single polarization line 363 is formed. In this case, two central branch passages 355 are formed about both ends of the polarization line 363.

Of course, when two magnets are installed in the ring frame 351 so that two pairs of N-polarities and S-polarities are alternately disposed, more than two polarization lines are formed. In this case, four central branch passages are formed along an inner circumferential surface of the ring frame 351 at 90° intervals.

As described above, it is possible to increase an amount of the fluid passing through the central branch passages 355 by increasing the number of the central branch passages 355 or enlarging cross-sectional areas of the central branch passages 355. As a result, it is possible to more effectively cool the magnet 360 and the ring frame 351.

In addition, since the central branch passages 355 are formed about the polarization lines 363, contact surfaces between the N-polarities 361 and the S-polarities 362 are reduced. As a result, it is possible to reduce a fine magnetic field between the N-polarities 361 and the S-polarities 362, and interference between the stator and the remaining magnetic field. Further, since reduction of the interference of the magnetic fields can reduce magnetic loss, it is possible to increase operating efficiency of the rotor.

Meanwhile, a first communication part 357 may be formed between the introduction passage 330 and the central branch passage 355 to be in communication with the passages 330 and 355 such that the fluid moves to the central branch passages 355 through the introduction passage 330. Here, the first communication part 357 may be formed as a space formed inside the ring frame 351, which is defined by one surface of the magnet 360 and the other surface of the lower frame 353 opposite to the one surface of the magnet 360 by forming the magnet 360 shorter than the ring frame 351 at its both ends by predetermined distances.

As a result, the fluid passed through the introduction passage 330 can move to the central branch passages 355 via the first communication part 357.

Of course, the magnet 360 may have the same length as the ring frame 351. In this case, the first connection passage may be configured to have a funnel shape such that the introduction passage expands toward the other end of the lower frame with a predetermined angle to make an end of the introduction passage equal to an outer diameter of the magnet. In addition, the first connection passage may be configured such that a trench having a predetermined depth and width is formed at the other end of the lower frame in a radial direction and an end of the introduction passage is in communication with a center part of the trench.

Meanwhile, an upper frame 352 may be coupled with one side of the ring frame 351 in its axial direction to be opposite to the lower frame 353 coupled with the ring frame 351 in various manners such as a threaded engagement, a welding, and a press fitting. Here, the upper frame 352 and the ring frame 351 may be formed of the same material so that they can be readily fixed to each other through the welding.

Further, a discharge passage 345 may be formed in the upper frame 352 to pass through one end of the upper frame 352 in its axial direction such that the fluid passed through the central branch passages 355 can move.

The discharge passage 345 may be formed through the upper frame 352 in its axial direction by a predetermined distance and then branched to pass through the upper frame 352 in its radial direction to form discharge branch passages 350 to discharge the fluid to the exterior of the upper frame 352. Here, the discharge branch passages 350 may form a predetermined angle with an axial direction of the discharge passage 345 to form at least two discharge paths. Therefore, rotation of the rotor generates a centrifugal force in the discharge branch passages 350 so that the fluid can more smoothly flow in the discharge branch passages 350.

Meanwhile, the central branch passages 355 may be in communication with the discharge passage 345 through a second communication part 356, which may be formed to correspond to the first communication part 357.

Therefore, the fluid introduced into the introduction passage 330 moves to the central branch passages 355 through the first communication part 357 formed between the lower frame 353 and the ring frame 351. Then, the fluid moves to the discharge passage 345 through the second communication part 356 formed between the ring frame 351 and the upper frame 352, and then is discharged to the exterior through the discharge branch passages 350.

Meanwhile, the lower frame 353 may be integrally formed with the ring frame 351, or the ring frame 351 may be integrally formed with the upper frame 352.

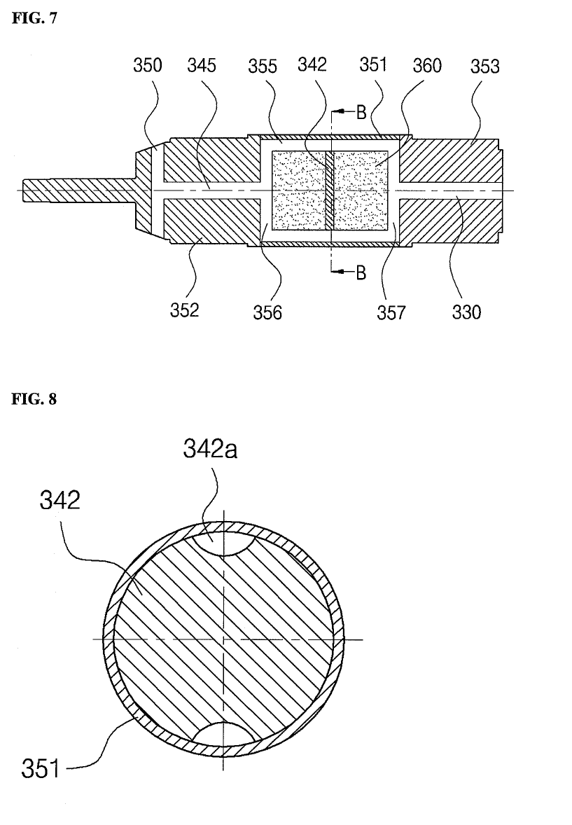

FIG. 7 is a longitudinal cross-sectional view of a rotor in accordance with still another exemplary embodiment of the present invention, and FIG. 8 is a cross-sectional view taken along line B-B of FIG. 7. The basic constitution of the embodiment of FIG. 7 is the same as the embodiment of FIG. 3, so its description will not be repeated.

As shown in FIGS. 7 and 8, a reinforcement member 342 having a predetermined thickness may be installed in the ring frame 351. Here, the reinforcement member 342 may be installed at a center part of the ring frame 351. Magnets 360 are installed at both sides of the reinforcement member 342. The reinforcement member 342 may have through-holes 342a in communication with the central branch passages 355.

Of course, the reinforcement member 342 may be integrally formed with the ring frame 351, or may be formed as a separate member to be inserted into the ring frame 351. In addition, a plurality of reinforcement members may be installed depending on the length and thickness of the ring frame 351.

As a result, it is possible to prevent damage of the ring frame 351 due to vibration or centrifugal load of the magnet 360 applied to the ring frame 351, which can be generated when the rotor is rotated.

As can be seen from the foregoing, effects of a high speed electric motor in accordance with exemplary embodiments of the present invention will be described as follows.

First, since a cooling passage is installed in the high speed electric motor, it is possible to rapidly discharge heat generated from a rotor, thereby effectively cooling the rotor.

Second, a centrifugal impeller is installed at one end of the rotor to function as a discharge post of a cooling fluid so that flow of the cooling fluid can be remarkably improved due to suction force of the centrifugal impeller.

Third, it is possible to improve durability of the rotor by rapidly discharging the heat generated from the rotor.

Fourth, when an upper frame, a ring frame, and a lower frame are assembled to each other to form the rotor, it is possible to remarkably improve productivity and assembly performance.

While few exemplary embodiments of the present invention have been shown and described, it will be appreciated by those skilled in the art that various changes may be made to these embodiments without departing from the spirit and scope of the invention as defined by the appended claims and their equivalents.

What is claimed is:

1. A high speed electric motor comprising:
a stator installed at an inner circumferential surface of a motor housing; and
a rotor installed inside the rotor to form a rotational magnetic field by application of a current to the stator, and having a cooling passage through which fluid flows and a magnet installed at one side of the cooling passage.

2. The high speed electric motor according to claim 1, wherein the cooling passage comprises:
a main passage formed in the rotor in an axial direction and having one end passing through a tip of the rotor; and
discharge branch passages extending from the other end of the main passage through an outer circumferential surface of the rotor and divided into at least two branch paths.

3. The high speed electric motor according to claim 2, wherein the discharge branch passages are formed perpendicular to the axial direction of the rotor.

4. The high speed electric motor according to claim 2, wherein the discharge branch passages form an obtuse angle with the main passage.

5. The high speed electric motor according to claim 1, further comprising a centrifugal impeller engaged with an end of the rotor to be rotated therewith and blowing a cooling fluid.

6. The high speed electric motor according to claim 1, wherein a main frame is installed at a center part of the rotor to have a convex shape, and a magnet is coupled with the main frame along an inner circumferential surface of the main frame.

7. The high speed electric motor according to claim 1, wherein a reinforcement frame is installed inside the main frame to reinforce the main frame.

8. The high speed electric motor according to claim 1, wherein the rotor comprises:
a lower frame disposed inside the rotor in an axial direction of the rotor which is installed at an inner circumferential surface of the motor housing and receives power to generate a magnetic force, and having an introduction passage formed through its one end to introduce fluid thereinto;
a ring frame coupled with the other end of the lower frame in its axial direction, and having a hollow cylindrical space;
a magnet installed inside the ring frame to form a rotational magnetic field by application of a current to the stator, and having central branch passages formed at its outer circumferential surface in its axial direction to be in communication with the introduction passage to move the fluid introduced through the introduction passage; and
an upper frame coupled with an end of the ring frame in its axial direction, and having a discharge passage installed at its inner circumferential surface in its axial direction to be in communication with the central branch passages to discharge the fluid flowing toward the central branch passages.

9. The high speed electric motor according to claim 8, wherein the central branch passages have a symmetrical cross-section about a polarization line of the magnet.

10. The high speed electric motor according to claim 1, wherein the lower frame is integrally formed with the ring frame.

11. The high speed electric motor according to claim 1, wherein the ring frame is integrally formed with the upper frame.

12. The high speed electric motor according to claim 1, wherein the discharge passage is branched into at least two discharge branch passages passing through an outer circumferential surface of the upper frame at an end of the discharge passage such that the fluid moving through the discharge passage is discharged to the exterior of the upper frame.
